(19) United States
(12) Patent Application Publication
(10) Pub. No.: US 2007/0234548 A1
(43) Pub. Date: Oct. 11, 2007

(54) METHOD AND APPARATUS FOR ALIGNING A LIFTGATE

(76) Inventor: Kenneth Rock, Tallmadge, OH (US)

Correspondence Address: BROUSE MCDOWELL LPA, 388 SOUTH MAIN STREET, SUITE 500, AKRON, OH, 44311, US

(21) Appl. No.: 11/278,679

(22) Filed: Apr. 5, 2006

(51) Int. Cl. B23Q 3/00

(52) U.S. Cl. 29/464

(57) ABSTRACT

A liftgate may be aligned to a vehicle by: (a) attaching at least one guide member having an aligmnent member with a contact surface to the liftgate; (b) adjusting the alignment member into a first open position; (c) positioning the liftgate at least partially under the vehicle to a position adjacent to the vehicle; (d) adjusting the alignment member into a second closed position; (e) positioning the liftgate such that the contact surface contacts the vehicle; (f) attaching the liftgate to the vehicle; and, (g) removing the guide member from the liftgate.

### I. BACKGROUND OF THE INVENTION

A. Field of Invention

This invention pertains to the art of methods and apparatuses regarding liftgates and more specifically to methods and apparatuses regarding aligning a liftgate to a vehicle.

B. Description of the Related Art

It is well known in the art to attach liftgates to vehicle trailers or other forms of vehicle cargo holds to assist with loading and unloading of the vehicles. In general, liftgates include a platform and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, and rail type liftgates. Some liftgates are designed to attached to the back of a vehicle while others are designed to attach to the side of a vehicle. In every case, it is important to carefully align the liftgate to the vehicle so that the liftgate operates properly without binding or unwanted interference.

Currently known methods for aligning a liftgate to a vehicle include the use of carpenter squares, diagonal measurements of the vehicle doorway, and physical marking of center points. While these methods work well for their intended purpose, they are rather time consuming. In addition, these know methods are not very effective for side-to-side alignment of the liftgate to the vehicle.

The present invention provides methods and apparatuses for easily and accurately aligning a liftgate to a vehicle and thereby overcomes the foregoing difficulties and others while providing better and more advantageous overall results.

### II. SUMMARY OF THE INVENTION

According one embodiment of this invention, a liftgate assembly may include a liftgate adapted to be attached to a vehicle and a liftgate alignment assembly used to align the liftgate with respect to the vehicle.

According to another embodiment of this invention, a liftgate alignment assembly includes a guide member having a body portion adapted to be attached to a liftgate and an alignment member operatively connected to the body portion with a contact surface used to contact a vehicle surface. The alignment member may be adjusted to a first open position that minimizes the likelihood that the alignment member will contact the vehicle and to a second closed position where the contact surface faces the vehicle surface.

According to another embodiment of this invention, the body portion may have first and second arms. The alignment member may be moved between the first and second positions relative to the first arm. The second arm may have an attachment surface adapted to be attached to the liftgate.

According to another embodiment of this invention, the alignment member is pivotally attached to the body portion.

According to another embodiment of this invention, the alignment member is slidably attached to the body portion.

According to still another embodiment of this invention, a lock mechanism is provided and is used to preventing the alignment member from moving relative to the body portion.

According to another embodiment of this invention, a lip extends from the body portion and is used to maintain the alignment member in the second position.

According to still another embodiment of this invention, a method of aligning a liftgate to a vehicle is provided. The method may include the steps of: (a) providing first and second guide members each having an alignment member with a contact surface; (b) attaching the first and second guide members to the liftgate; (c) adjusting each alignment member into a first open position; (d) positioning the liftgate at least partially under the vehicle to a position adjacent to the vehicle; (e) adjusting each alignment member into a second closed position; (f) positioning the liftgate such that each contact surface contacts a vehicle surface; (e) attaching the liftgate to the vehicle; and, (f) removing the first and second guide members from the liftgate.

According to anther embodiment of this invention, the first guide member is attached to one side of the liftgate's longitudinal axis and the second guide member is attached to the other side of the liftgate's longitudinal axis.

According to another embodiment of this invention, the aligmnent member may be selectively locked with respect to the guide member.

One advantage of this invention is it makes it very easy to properly align a liftgate to a vehicle.

Another advantage of this invention is that it is inexpensive to produce.

Another advantage of this invention is that it is very easy to install and then remove the guide members once the liftgate has been aligned.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a liftgate assembly prior to installation on a vehicle showing an alignment assembly according to one embodiment of this invention.

FIG. 2 is a front view of the liftgate assembly of FIG. 1.

FIG. 3 is a cutaway side view of a vehicle showing the liftgate of FIGS. 1 and 2 being aligned.

FIG. 4 is a perspective view of a guide member according to one embodiment of this invention.

FIG. 5 is a side view of the guide member of FIG. 4 shown in a first open position.

FIG. 6 is a side view of the guide member of FIG. 4 shown in a second closed position.

FIG. 7 is an exploded view of a portion of the view of FIG. 3 showing how the alignment member contacts the vehicle surface.

FIG. 8 is a side view of a portion of a guide member according to one embodiment showing the aligmnent member unattached to the body portion.

FIG. 9 is a view similar to that shown in FIG. 8 but showing another embodiment where the holes used to attach the alignment member to the body portion are replaced with grooves.

### IV. DETAILED DESCRIPTION OF THE INVENTION

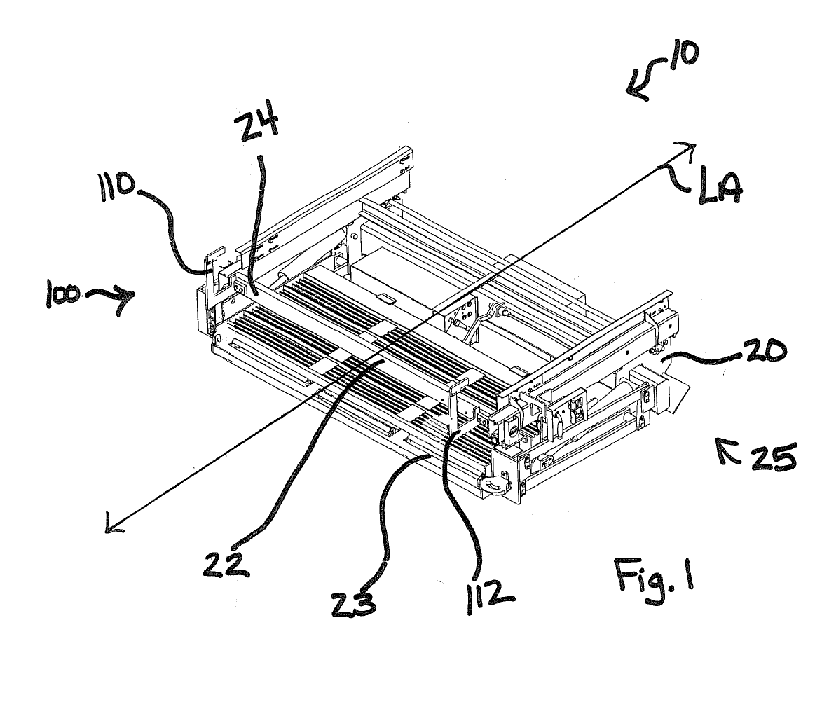

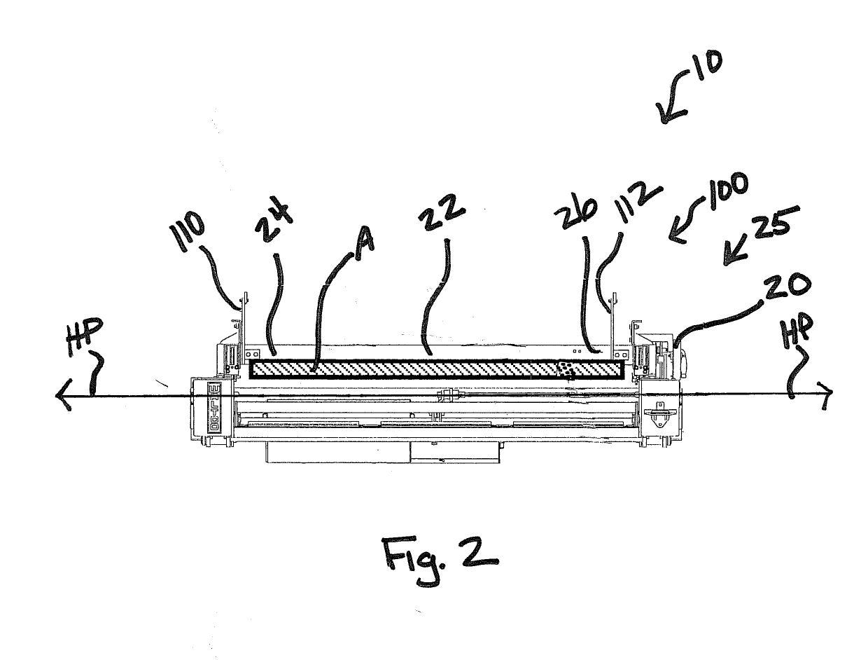

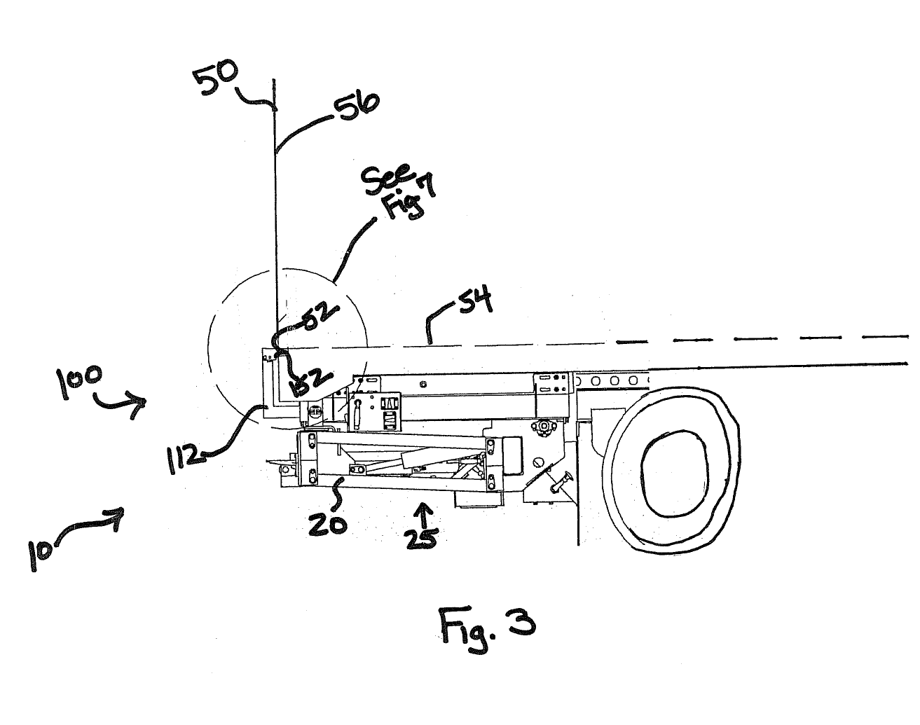

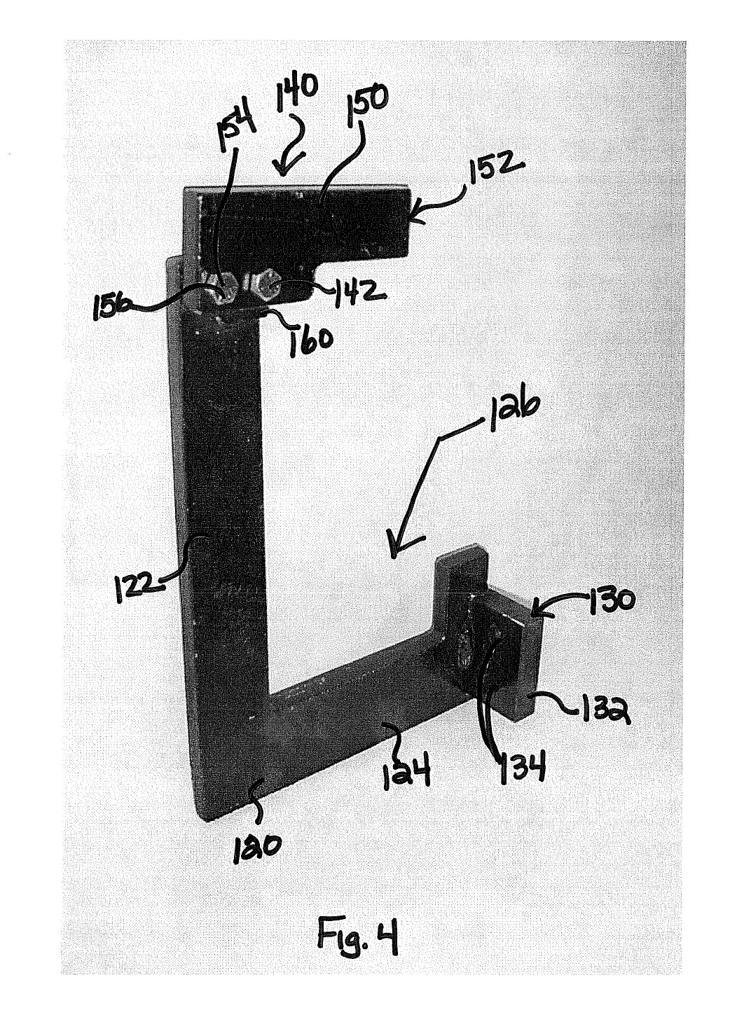

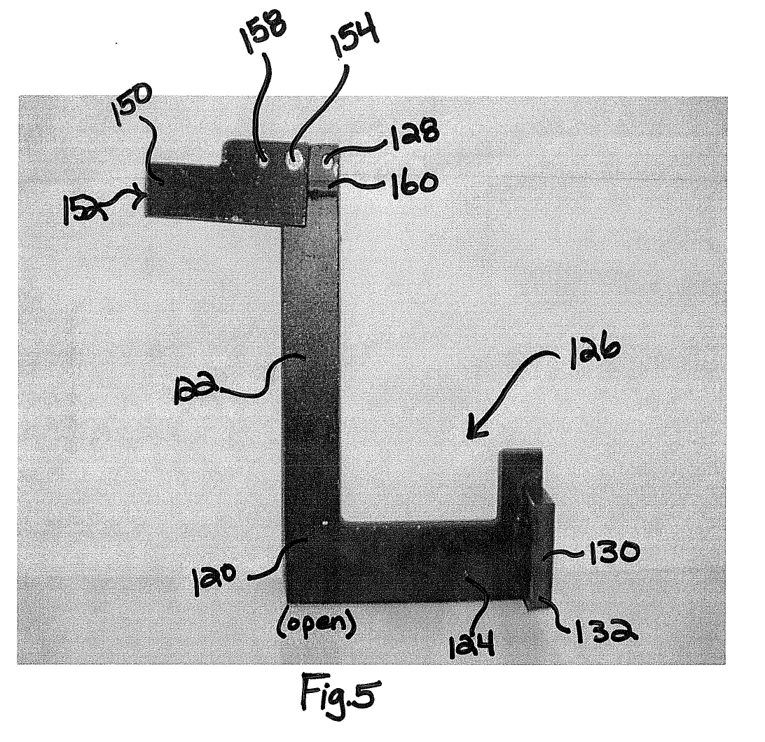

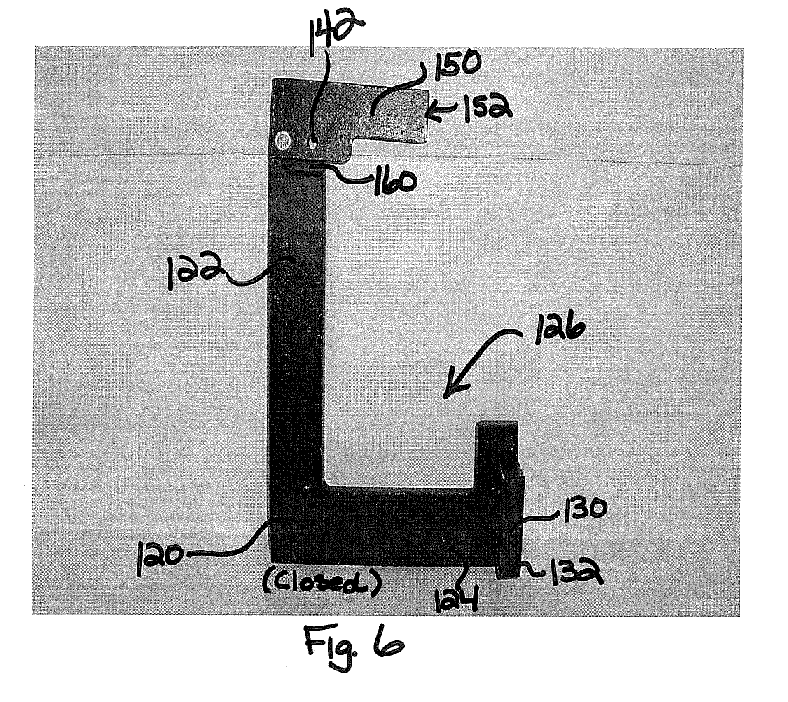

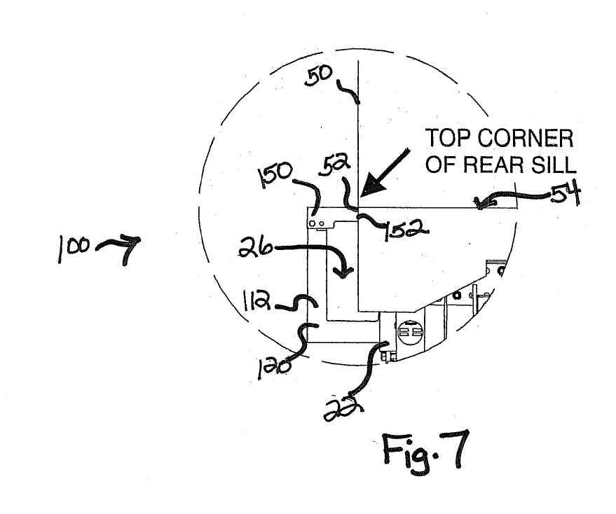

Referring now to the drawings wherein the showings are for purposes of illustrating embodiments of the invention only and not for purposes of limiting the same, FIGS. 1 and 2 show a liftgate assembly 10 including a liftgate 20 and a liftgate alignment assembly 100 according to this invention. The liftgate 20 includes a platform 23 and a platform movement system 25 for use in moving the platform 23. As the operation of a liftgate 20 is well known in the art, it will not be discussed in detail here. While the liftgate 20 shown is the style known as flip-a-way or fold-up, it is to be noted that the alignment assembly 100 of this invention will work with any liftgate style, type and size, when applied with sound engineering judgment.

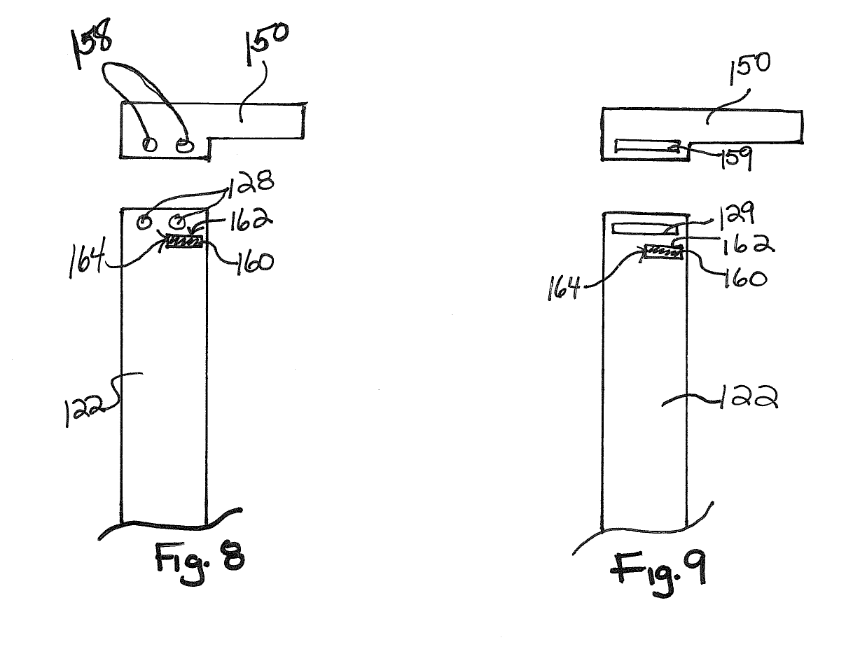

FIGS. 3 and 7 show the liftgate assembly 10 of FIGS. 1 and 2 being installed onto a vehicle 50. The vehicle shown is a truck including a trailer or cargo hold 56 and a bed 54. As is well known in the art, cargo is placed onto the bed 54 so that it can be transported by the vehicle 50. It should be noted that the alignment assembly 100 of this invention works with any type of cargo hold 56 whether attached directly to a truck, or to a separate trailer or to another vehicle such as a van. It should also be noted that while the liftgate 20 is shown attached to the back end of the vehicle 50, the alignment assembly 100 of this invention will work with liftgates 20 attached to any portion, for example on the side or front, of a vehicle's cargo hold 56. The bed 54 has a back end defining a vehicle surface commonly known as a rear sill. According to one embodiment of this invention, the later to be described alignment member 150 contacts the rear sill. As is well known, the rear sill extends across the width of the bed 54. Thus, the sill provides multiple vehicle surfaces 52 which the alignment assembly 100 of this invention may contact, as is described further below. However, it should be noted that any vehicle surface 52 that is generally perpendicular to the bed 54 can be used with the alignment assembly 100 of this invention. Another non-limiting example of surfaces that may be used as vehicle surfaces 52 are the sides of the cargo hold.

With reference now to FIGS. 1-7, the alignment assembly 100 includes at least one and preferably a pair of guide members 110, 112. Each guide member 110, 112 includes a body portion 120 and an alignment member 150. The body portion 120 is adapted to be attached to the liftgate 20 and remain attached while the liftgate 20 is moved during installation onto the vehicle 50. In one embodiment, each body portion 120 includes first and second anus 122, 124. The alignment member 150 may be operatively connected to the first arm 122. The second arm 124 may have an attachment surface 130 adapted to be attached to the liftgate 20. While the attachment surface 130 can be of any design chosen with sound engineering judgment, in the embodiment shown the attachment surface 130 is defined on a flange member 132 having one or more holes 134 (two shown). The holes 134 may receive bolts (not shown) to hold the guide members 110, 112 to the liftgate 20. Of course any maimer of attaching the guide member 110, 112 to the liftgate 20 chosen with sound engineering judgment will work with this invention. The first and second arms 122, 124 define a space 126 between them which will serve a function to be described below. In one embodiment, the first and second arms 122, 124 are substantially L-shaped, as shown. For this embodiment, when the guide member 110, 112 is attached to the liftgate 20, the first arm 122 may be substantially parallel to a horizontal plane HP (shown in FIG. 2) of the liftgate 20 while the second arm 124 is substantially perpendicular to the horizontal plane HP of the liftgate 20. This positioning of the guide member 110, 112 provides for easy alignment of the liftgate 20 to the vehicle 50.

With continuing reference to FIGS. 1-7, each alignment member 150 may be moveably connected to the corresponding body portion 120. The alignment member 150 also may have a contact surface 152 that is adapted to contact the vehicle surface 52 for alignment purposes to be described further below. The alignment member 150 may be positioned into a first or opened positioned (shown in FIG. 5) and in a second or closed position (shown in FIG. 6). As shown, when in the open position the portion of the alignment member 150 that includes the contact surface 152 is positioned away from the space 126. As a result, the alignment member 150 is positioned such that it will minimize the likelihood that the alignment member 150 will contact the vehicle 50 as the liftgate 20 is being positioned with respect to the vehicle 50. When in the second closed position (shown in FIG. 6), the contact surface 152 faces toward the vehicle surface 52 when the liftgate 20 is positioned against the vehicle 50 as will be described further below. In one embodiment, the alignment member 150 is pivotally attached to the body portion 120. Thus, the alignment member 150 can be pivoted from the first opened position shown in FIG. 5 to the second closed position shown in FIG. 6. With reference to FIGS. 5 and 8, the alignment member 150 may pivot about a pivot pin inserted through an opening 158 formed in the alignment member 150 and a corresponding opening 128 formed in the body portion 120. This pivot pin may take the form of a bolt 154 or may take any other from chosen with sound engineering judgment.

With reference now to FIGS. 4-6 and 8, in another embodiment a lip member 160 may extend from the body portion 120. The lip member 160 may be attached to the body portion 120 by any manner chosen with sound engineering judgment such as by welding. In an alternate embodiment, the lip member 160 may be formed as a single piece with the body portion 120. The lip member 160 may include a first surface 162 and a second surface 164. These surfaces 162, 164 are used to contact the alignment member 150 in a manner to be described further below.

With reference now to FIGS. 4-8, a lock mechanism 140 may be used to lock the alignment member 150 with respect to the body portion 120. In the embodiment shown, the lock mechanism 140 is used to lock the alignment member 150 into the second closed position. This is useful in preventing the alignment member 150 from movement relative to the body portion 120 as the liftgate 20 is being positioned with respect to the vehicle 50. More specifically, the lock mechanism 140 prevents inadvertent movement of the alignment member 150 as the liftgate 20 is being positioned with respect to the vehicle 50. In one embodiment, shown in FIG. 4, the lock mechanism 140 includes a bolt 142 received within an opening 158 in the alignment member 150 and an opening 128 formed in the body portion 120. By tightening this bolt 142 the alignment member 150 is held fixed relative to the body portion 120. Of course, other means of holding the alignment member 150 with respect to the body portion 120 could work equally well such as via the use of a clamp, rope, wire, or the like.

With reference now to FIGS. 1-8, a method of aligning the liftgate 20 to the vehicle 50 in accordance with this invention will now be described. First, at least one and preferably two guide members 110, 112 are attached to the liftgate 20. The attachment surface 130 may be used for this attachment. It should be noted that while the guide members 110, 112 may be attached to any portion of the liftgate 20 chosen with sound engineering judgment, in one embodiment the liftgate 20 includes a support member 22, shown in FIGS. 1 and 2. In one embodiment, as shown, the support member 22 extends substantially perpendicular to the longitudinal axis LA of the liftgate 20. When two guide members 110, 112 are used, preferably one will be attached to one end 24 of the support member 22 while the other is attached to the second end 26 of the support member 22, as shown. Preferably but not essentially, when two guide members 110, 112 are used, one is positioned on one side of the longitudinal axis LA of the liftgate 20 and the other is positioned substantially equal distance from the longitudinal axis LA on the opposite side. This positioning maximizes the side-to-side alignment capability of the guide members 110, 112.

With continuing reference to FIGS. 1-8, once the guide members 110, 112 are attached to the liftgate 20 each alignment member 150 should be placed into the first open position (shown in FIG. 5). The liftgate 20 including the guide members 110, 112 can then be positioned under the vehicle 50 and lifted using for example a forklift truck (not shown), until the liftgate 20 is adjacent to the vehicle 50 as shown in FIG. 3. In one embodiment, the forklift truck forks (not shown) can be received within area A, shown shaded in FIG. 2, and thus the support member 22 can be used not only to support the guide members 110, 112 but also to support the entire liftgate 20 as it is raised by the forklift truck. As seen best in FIG. 7, at least a portion of the vehicle 50 can be received within space 26 without the alignment member 150 contacting the vehicle 50.

Still referring to FIGS. 1-8, in one embodiment, when the alignment member 150 is placed into the first open position the aligmnent member 150 contacts the second surface 164 of the lip 160 as seen best in FIG. 5 (note that the first and second surfaces of the lip are referenced in FIG. 8). Once the liftgate 20 is positioned adjacent to the vehicle 50, the alignment members 150 can be positioned into the second closed position shown in FIG. 6. When in the second position, the contact surface 152 faces toward the vehicle 50 and more specifically the vehicle surface 52. In one embodiment, positioning the alignment member into the second position includes contacting the alignment member 150 to the first surface 162 of the lip 160. In this way, the lip 160 helps maintain the alignment member 150 in the second position. More specifically, the lip 160 may be used to maintain the alignment member 150 such that the contact surface 152 is maintained substantially parallel to the vehicle surface 52. In another embodiment, the lock mechanism 140 may be used to maintain the alignment member 150 in the second position.

With continuing reference to FIGS. 1-8, once the alignment member 150 is placed into the second position, the liftgate 20 can be positioned such that each contact surface 152 contacts the vehicle surfaces 52. More specifically, the contact surface 152 of one guide member 110 contacts the vehicle surface 52 on one side of the vehicle 50 while simultaneously the contact surface 152 of the other guide member 112 contacts the vehicle surface 52 on the opposite side of the vehicle 50. It is easy for the operator to see that both contact surfaces 152 are contacting the vehicle surfaces 52 and thus it is easy to achieve proper side-to-side alignment of the liftgate 20 with respect to the vehicle 50. Once appropriate alignment has been achieved, the liftgate 20 may be attached to the vehicle 50. The particular methods for attaching a liftgate 20 to a vehicle 50 are well known in the art and thus will not be described here. Once the liftgate is attached to the vehicle 50 the guide members 110, 112 may be removed from the liftgate 20. The guide members 110, 112 may then be stored for additional use in the future, if desired.

Multiple embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof. One alternate embodiment concerns the movement of the alignment member 150 with respect to the body portion 120. As described above, the alignment member 150 may pivot with respect to the body portion 120. However, in an alternate embodiment illustrated in FIG. 9, the alignment member 150 may slide on the lip 160 between the opened and closed positions. This may be accomplished, for example, by providing a groove 159 in the alignment member 150 and a corresponding groove 129 in the body portion 120. The alignment member 150 may rest on the first surface 162 of the lip 160. A bolt may be used and received within the grooves 159, 129. With the bolt in a loose condition, the alignment member 150 can be easily slid along the lip 160 between the first and second positions. Once the desired position is achieved, the bolt only needs to be tightened to maintain the alignment member 150 in the appropriate position.

Another alternate embodiment concerns the design of the guide members 110, 112. As shown in FIGS. 1 and 2, the guide members 150 are virtually identical. Thus, for example, the alignment members 150 are positioned on the light hand side of the body portion 120. The advantage to this embodiment is that each guide member 110, 112 can be made essentially identical to the others. This minimizes costs and inventory. In an alternate embodiment, however, the guide members 110, 112 may be “mirror images.” In this case, while the alignment member 150 would be attached on the right hand side of one body portion 120, for the other opposite guide member the alignment member 150 would be attached on the left hand side of the body portion 120. The attachment surface 130 may similarly be placed on the opposite side of the body portion 120. The advantage to this embodiment is that it is even easier to attach the guide members 110, 112 to the liftgate 20 such that the contact surfaces 152 are equal distance from the longitudinal axis LA of the liftgate 20. This increases the accuracy of the side-to-side alignment.

The particular materials used to form the guide members 110, 112 can be any sufficient to align the liftgate 20 as described above. In one embodiment, each alignment member 150 and body portion 120 are formed from steel. In another embodiment, each alignment member 150 and body portion 120 are formed of plastic. In yet another embodiment, each alignment member 150 may be formed of one material (steel, for example) while each body portion 120 may be formed of a second material (plastic, for example).

Having thus described the invention, it is now claimed:

I/We claim:

1. A method of aligning a liftgate to a vehicle having first and second vehicle surfaces, comprising the steps of:
providing first and second guide members each comprising first and second alignment members having first and second contact surfaces, respectively;
attaching the first and second guide members to the liftgate;
adjusting the first and second alignment members into a first position;
positioning the liftgate at least partially under the vehicle to a position adjacent to the vehicle;
adjusting the first and second alignment members into a second position;
positioning the liftgate such that the first contact surface contacts the first vehicle surface and the second contact surface contacts the second vehicle surface simultaneously;
attaching the liftgate to the vehicle; and,
removing the first and second guide members from the liftgate.

2. The method of claim 1 wherein the step of, attaching the first and second guide members to the liftgate, comprises the steps of:
attaching the first guide member to the liftgate on one side of a longitudinal axis of the liftgate; and,
attaching the second guide member to the liftgate on an opposite side of the longitudinal axis.

3. The method of claim 2 further comprising the steps of:
providing the liftgate with a support member that extends substantially perpendicular to the longitudinal axis;
wherein the step of, attaching the first guide member to the liftgate, comprises the step of attaching the first guide member to one end of the support member; and,
wherein the step of, attaching the second guide member to the liftgate, comprises the step of attaching the second guide member to an opposite end of the support member.

4. The method of claim 1 wherein:
the step of, adjusting the first and second alignment members into a first position, comprises the step of moving the first and second alignment members to a position minimizing the likelihood that the first and second alignment members will contact the vehicle; and,
the step of, adjusting the first and second alignment members into a second position, comprises the steps of:
(a) moving the first alignment member to a position where the first contact surface faces the first vehicle surface; and,
(b) moving the second alignment member to a position where the second contact surface faces the second vehicle surface.

5. The method of claim 4 wherein:
the step of, moving the first alignment member to a position where the first contact surface faces the first vehicle surface, comprises the step of contacting the first alignment member to a first surface of a first lip extending from the first guide member; and,
the step of, moving the second aligmnent member to a position where the second contact surface faces the second vehicle surface, comprises the step of contacting the second alignment member to a first surface of a second lip extending from the second guide member.

6. The method of claim 5 wherein the step of, moving the first and second aligmnent members to a position minimizing the likelihood that the first and second alignment members will contact the vehicle, comprises the steps of:
contacting the first alignment member to a second surface of the first lip; and,
contacting the second alignment member to a second surface of the second lip.

7. The method of claim 4 wherein:
after the step of, moving the first alignment member to a position where the first contact surface faces the first vehicle surface, the method comprises the step of locking the first alignment member with respect to the first guide member; and,
after the step of, moving the second alignment member to a position where the second contact surface faces the second vehicle surface, the method comprises the step of locking the second alignment member with respect to the second guide member.

8. The method of claim 1 wherein:
the step of, providing first and second guide members, comprises the step of providing each of the first and second guide members with first and second arms defining a space between them; and,
the step of, positioning the liftgate at least partially under the vehicle to a position adjacent to the vehicle, comprises the step of placing a portion of the vehicle within the spaces.

9. A liftgate alignment assembly comprising:
a first guide member comprising:
(a) a body portion adapted to be attached to a liftgate and remain attached while the liftgate is moved;
(b) an alignment member operatively connected to the body portion and having a contact surface adapted to contact a vehicle surface; and,
(c) wherein the alignment member is selectively adjustable to a first position minimizing the likelihood that the aligmnent member will contact the vehicle and to a second position where the contact surface faces the vehicle surface.

10. The liftgate aligmnent assembly of claim 9 wherein the body portion comprises:
first and second arms, wherein the alignment member is operatively connected to the first arm and the second arm has an attachment surface adapted to be attached to the liftgate.

11. The liftgate alignment assembly of claim 10 wherein the body portion is substantially L-shaped and wherein when attached to the liftgate the first arm is substantially parallel to a horizontal plane of the liftgate and the second arm is substantially perpendicular to the horizontal plane of the liftgate.

12. The liftgate alignment assembly of claim 9 wherein the alignment member is pivotally attached to the body portion.

13. The liftgate alignment assembly of claim 12 further comprising:
a pivot pin about which the alignment member pivots; and,
a lock mechanism for preventing the alignment member from pivoting.

14. The liftgate alignment assembly of claim 9 wherein the alignment member is slidably attached to the body portion.

15. The liftgate alignment assembly of claim 9 further comprising:
a lip extending from the body portion for use in maintaining the alignment member in the second position.

16. The liftgate aligmnent assembly of claim 9 further comprising:
a second guide member comprising:
(a) a body portion adapted to be attached to the liftgate and remain attached while the liftgate is moved;
(b) an alignment member operatively connected to the body portion and having a contact surface adapted to contact another vehicle surface; and,
(c) wherein the alignment member is selectively adjustable to a first position minimizing the likelihood that the alignment member will contact the vehicle and wherein the aligmnent member is selectively adjustable to a second position where the contact surface faces the other vehicle surface.

17. A liftgate assembly comprising:
a liftgate adapted to be attached to a vehicle having a pair of vehicle surfaces; and,
a liftgate alignment assembly comprising: first and second guide members each comprising:
(a) a body portion adapted to be attached to the liftgate and remain attached while the liftgate is moved;
(b) an alignment member movably connected to the body portion and having a contact surface adapted to contact one of the vehicle surfaces; and,
(c) wherein the alignment member is selectively adjustable to a first position minimizing the likelihood that the alignment member will contact the vehicle and to a second position where the contact surface faces the corresponding vehicle surface.

18. The liftgate assembly of claim 17 wherein each body portion comprises:
first and second arms, wherein the alignment member is operatively connected to the first arm and the second arm has an attachment surface adapted to be attached to the liftgate.

19. The liftgate assembly of claim 18 wherein each body portion is substantially L-shaped and wherein when attached to the liftgate the first arm is substantially parallel to a horizontal plane of the liftgate and the second arm is substantially perpendicular to the horizontal plane of the liftgate.

20. The liftgate assembly of claim 17 wherein each guide member further comprises:
a lock mechanism for locking the alignment member into the second position.
